(19) United States
(12) Patent Application Publication
(10) Pub. No.: US 2011/0156360 A1
(43) Pub. Date: Jun. 30, 2011

(54) SEAL DEVICE

(76) Inventors: Cheng-Hsiu Huang, Kaohsiung City (TW); Yi-Chieh Huang, Kaohsiung City (TW)

(21) Appl. No.: 12/980,565

(22) Filed: Dec. 29, 2010

(30) Foreign Application Priority Data
Dec. 31, 2009 (TW) 098146309

(51) Int. Cl. F16J 15/16

(52) U.S. Cl. 277/585

(57) ABSTRACT

A seal device includes a sleeve, a gland, a sealing assembly, an end collar and a protective cushion. The sleeve is adapted to be sleeved on a rotary shaft of a pumping machine and has inner and outer end portions in an axial direction. The gland is disposed around the sleeve, and is formed with a through hole that permits extension of the sleeve, and a receiving groove that communicates fluidly with the through hole and that is adapted for receiving cooling fluid. The sealing assembly is sleeved on the sleeve and is connected to the gland. The end collar is disposed around the sleeve and outside the gland. The protective cushion is disposed around the sleeve and between the gland and the end collar.

### CROSS-REFERENCE TO RELATED APPLICATION

This application claims priority of Taiwanese Application No. 098146309, filed on Dec. 31, 2009.

### BACKGROUND OF THE INVENTION

1.Field of the Invention

The invention relates to a sealing device, more particularly to a sealing device for a rotary shaft.

2. Description of the Related Art

A seal device is usually mounted on a stuffing box of a pumping machine to prevent leakage of fluid stirred in a chamber of the pumping machine due to high pressure in the chamber.

Referring to FIG. 1, a conventional seal device 2 disclosed in Taiwanese Utility Model No. M204360 includes a sleeve 21 sleeved on a rotary shaft 10 of a pumping machine 1, a first seal unit 22 disposed around the sleeve 21 and within a stuffing box 12 of the pumping machine 1, a first collar 23 disposed around the sleeve 21 proximate to an end of the stuffing box 12 and connected to the first seal unit 22, a gland 24 locked to the pumping machine 1 and abutted against the first collar 23, a second seal unit 25 disposed around the sleeve 21 and within the gland 24, and a second collar 26 disposed around the sleeve 21 and outside the gland 24.

The first seal unit 22 includes a first rotary ring 221 connected to the sleeve 21 via fastening pins 223, a first stationary ring 222, a first abutting ring 224 having a first end portion abutting against the first rotary ring 221 and a second end portion extending into the first stationary ring 222, and an abutment ring 225 disposed at one side of the first stationary ring 222 that is opposite to the first abutting ring 224. The first collar 23 is provided with a plurality of springs 231 disposed at an end portion of the first collar 23 proximate to the first seal unit 22 and abutting against the abutment ring 225. The gland 24 has a through hole 241 for permitting the sleeve 21 to pass therethrough, a receiving groove 242 proximate to the first collar 23 and in communication with the through hole 241, and an inlet 243 and an outlet 244 fluidly communicating with the receiving groove 242.

The second seal unit 25 includes a second rotary ring 251 that surrounds and is rotatable with the sleeve 21, a second stationary ring 252 disposed around the sleeve 21 and that has a first end portion received in the through hole 241 and a second end portion received in the receiving groove 242, and a second abutting ring 253 having a first end portion extending into the second rotary ring 251 and a second end portion abutting against the second stationary ring 252. The second rotary ring 251 is formed with a plurality of guiding recesses 255 at an outer peripheral surface thereof. A plurality of springs 254 are disposed between the second stationary ring 252 and the gland 24.

In operation, the pressure in the pumping machine 1 will increase when the liquid in the pumping machine 1 is pumped by rotating the rotary shaft 10. At this time, a leak proof effect is achieved when the first abutting ring 224 is abutted against the first rotary ring 221 by the springs 231 between the first collar 23 and the first seal unit 22, and the second stationary ring 252 is abutted against the second abutting ring 253 by the springs 254 between the second seal unit 25 and the gland 24. Furthermore, because the second rotary ring 251 is formed with the guiding recesses 255, a cooling fluid can be guided to flow into the receiving groove 242 via the inlet 243 and then out through the outlet 244 quickly and smoothly to achieve a satisfactory cooling effect.

However, because there is a gap between the gland 24 and the second collar 26, sparks may be generated when shaking of the pumping machine 1 during rotation of the rotary shaft 10 results in collisions between the gland 24 and the second collar 26, or between the gland 24 and other components mounted on the gland 24. If the cooling fluid is flammable or explosive, the cooling fluid may be ignited by the sparks, causing a fire or an explosion that causes severe damage to the pumping machine 1 or even serious injury to the operator of the pumping machine 1.

### SUMMARY OF THE INVENTION

Therefore, the object of the present invention is to provide a seal device that can avoid the abovementioned drawback.

Accordingly, a seal device of the present invention comprises a sleeve, a gland, a sealing assembly, an end collar and a protective cushion. The sleeve is adapted to be sleeved on a rotary shaft of a pumping machine and has inner and outer end portions in an axial direction . The gland is disposed around the sleeve, and is formed with a through hole that permits extension of the sleeve. The gland is further formed with a fluid chamber that communicates fluidly with the through hole and that is adapted for receiving cooling fluid. The sealing assembly is sleeved on the sleeve and is connected to the gland. The end collar is disposed around the sleeve outside the gland. The protective cushion is disposed around the sleeve between the gland and the end collar.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary sectional view of a conventional seal device disclosed in Taiwanese Utility Model No. M204360;

FIG. 2 is a fragmentary sectional view of a preferred embodiment of a seal device according to the invention;

FIG. 3 is a sectional view of a protection cushion of the preferred embodiment;

FIGS. 4 to 18 are sectional views of modified protection cushions of the preferred embodiment; and

FIG. 19 is an enlarged fragmentary sectional view of the preferred embodiment.

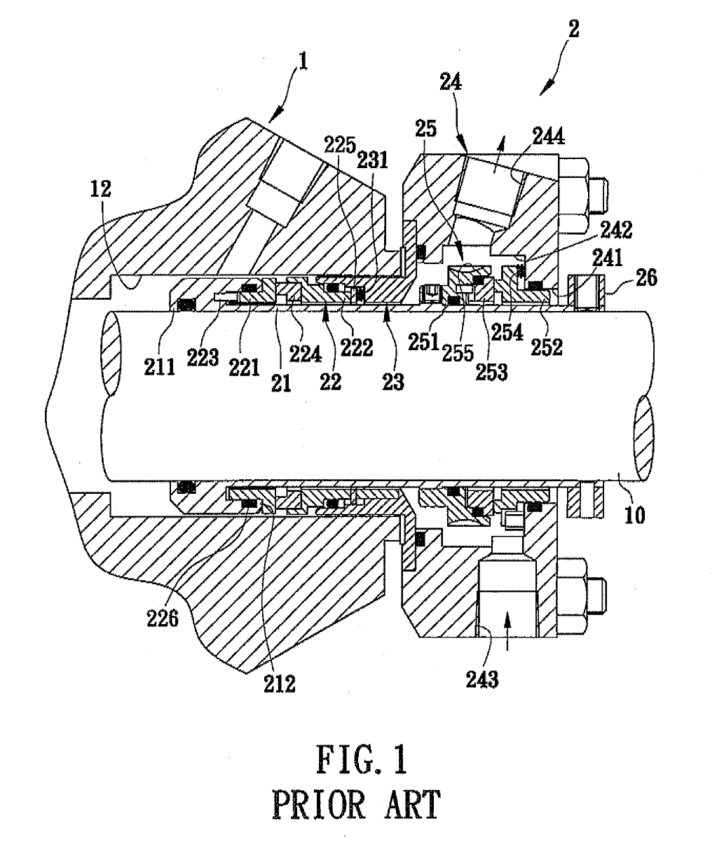

### DETAILED DESCRIPTION OF THE PREFERRED EMBODIMENT

The seal device according to the present invention may be embodied in a single seal device or a dual seal device.

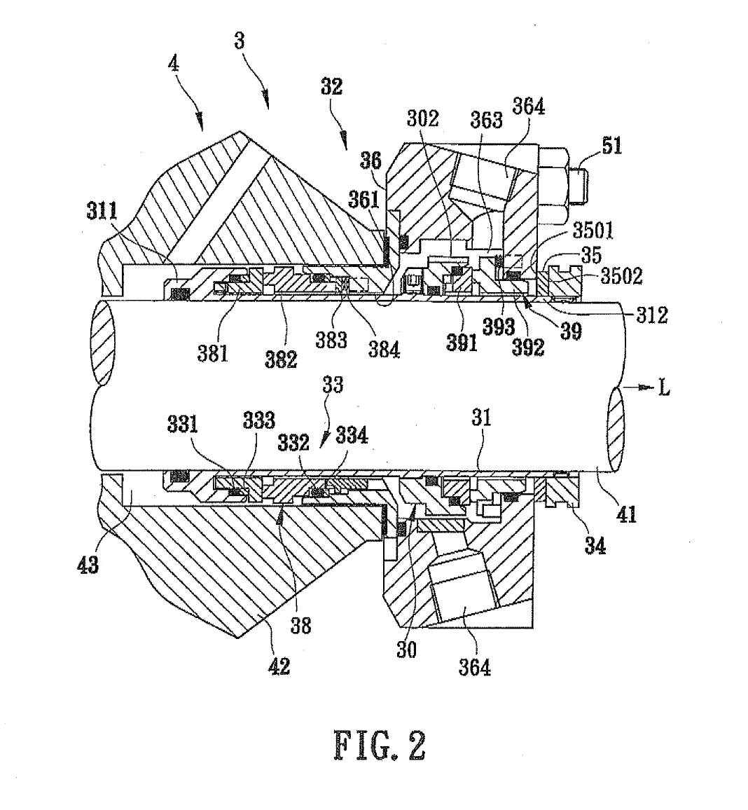

Referring to FIG. 2, the preferred embodiment of the seal device 3 according to the present invention is configured as a dual seal device adapted for use in a pumping machine 4. The seal device 3 comprises a sleeve 31, a gland 32, a sealing assembly 33, an end collar 34, a protective cushion 35 and a propelling ring 30.

The sleeve 31 is adapted to be sleeved on a rotary shaft 41 of the pumping machine 4, and has inner and outer end portions 311, 312 that are spaced apart from each other in an axial direction (L) and that are respectively proximate to and distal from a fluid to be stirred that is contained in the pumping machine 4.

The end collar 34 is disposed around the sleeve 31 outside the gland body 36 for securing the sleeve 31 on the rotary shaft 41 of the pumping machine 4. In this embodiment, the end collar 34 is connected separably to sleeve 31, but may be connected integrally to the sleeve 31 in other embodiments of this invention.

The gland 32 is disposed around the sleeve 31 and has a gland body 36. The gland body 36 is formed with a central hole 361 that permits extension of the sleeve 31 and the rotary shaft 41 of the pumping machine 4, and a receiving groove 363 that communicates fluidly with the through hole 361 and that is adapted for receiving cooling fluid. In this embodiment, the gland body 36 is further formed with a pair of circulation holes 364 communicating fluidly with the receiving groove 363 fox permitting the cooling fluid to enter and exit the receiving groove 363, respectively.

The sealing assembly 33 includes a first seal ring unit 38 and a second seal ring unit 39. The first seal ring unit 38 includes a first rotary ring 381 sleeved co-rotatably on the sleeve 31, a first stationary ring 382 disposed around the sleeve 31 and having an inner end that abuts against the first rotary ring 381 and an outer end that is opposite to the inner end in the axial direction (L), an abutment ring 383 disposed around the sleeve 31 and abutting against the outer end of the first stationary ring 382, and at least one first resilient member 384 having opposite ends that abut respectively against the abutment ring 383 and the gland body 36. The second seal ring unit 39 is disposed in the gland body 36, and includes a second rotary ring 391 disposed around the sleeve 31, a second stationary ring 392 having an inner end that abuts against the second rotary ring 391, and at least one second resilient member 393 disposed at an outer side of the second stationary ring 392 that is opposite to the second rotary ring 391 in the axial direction (L) and having opposite ends that abut respectively against the second stationary ring 392 and the gland body 36. The propelling ring 30 is disposed around the sleeve 31 and within the receiving groove 363, and is connected co-rotatably to the second rotary ring 391 such that the second rotary ring 391 is disposed between the propelling ring 30 and the second stationary ring 392. The propelling ring 30 has an outer periphery formed with a plurality of angularly spaced-apart propelling grooves 302. Each of the propelling grooves 302 has an axially extending portion for propelling the cooling fluid to flow from one of the circulation holes 364 to the other one of the circulation holes 364.

In additional, the sealing assembly 33 further includes a pair of fluid sealing rings 331, 332 sleeved respectively on the first and second stationary rings 381, 382, and a pair of packing rings 333, 334 in abutment with the fluid sealing rings 331, 332 respectively.

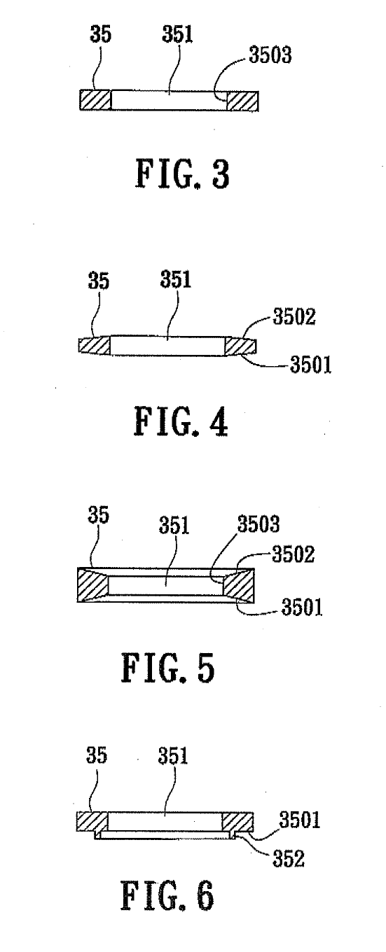

Further referring to FIG. 3, the protective cushion 35 is formed as a ring surrounding the sleeve 31, and is made of engineering plastic or a flameproof material. In this embodiment, the protective cushion 35 has first and second side surfaces 3501, 3502 facing respectively the gland body 36 and the end collar 34, and an inner annular surface 3503 defining a central hole 351 through which the sleeve 31 and the rotary shaft 41 extend.

In use, the gland body 36 is connected to a stuffing box 42 of the pumping machine 4 using a bolt 51. The stuffing box 42 has a space 43 for receiving a portion of the sleeve 31, a portion of the gland body 36, the first seal ring unit 38, the fluid sealing rings 331, 332, and the packing rings 341, 342. Because the sleeve 31 is fittingly sleeved around the rotary shaft 41 through the end collar 34, and because the first rotary ring 381 and the second rotary ring 391 are disposed around the sleeve 31, the sleeve 31, the first rotary ring 381, and the second rotary ring 391 rotatable with the rotary shaft 41. Furthermore, because the propelling ring 30 and the second rotary ring 391 are rotatable along with the sleeve 31, and because the outer periphery of the propelling ring 30 is formed with the propelling grooves 302, the cooling fluid can be guided quickly to flow smoothly in the receiving groove 363 via one of the circulation holes 364 and to exit smoothly out of the receiving groove 363 via the other one of the circulation holes 364 to enhance heat dissipation efficiency.

By virtue of the protective cushion 35, when the rotary shaft 41 is rotated at high speed, collisions between the end collar 34 and the gland body 36 can be avoided, thereby improving the service life of the seal device 3 of this invention.

Referring to FIGS. 4 and 5, a modified protective cushion 35 is illustrated in which the first and second side surfaces 3501, 3502 are inclined surfaces such that the protective cushion 35 has a thickness tapering in a radial direction away from the inner annular surface 3503 (see FIG. 4) , or tapering toward the inner annular surface 3503 (see FIG. 5). Such a configuration can reduce contact area between the protective cushion 35 and the end collar 34, thereby avoiding generation of heat and noise relative rotation between the protective cushion 35 and the end collar 34.

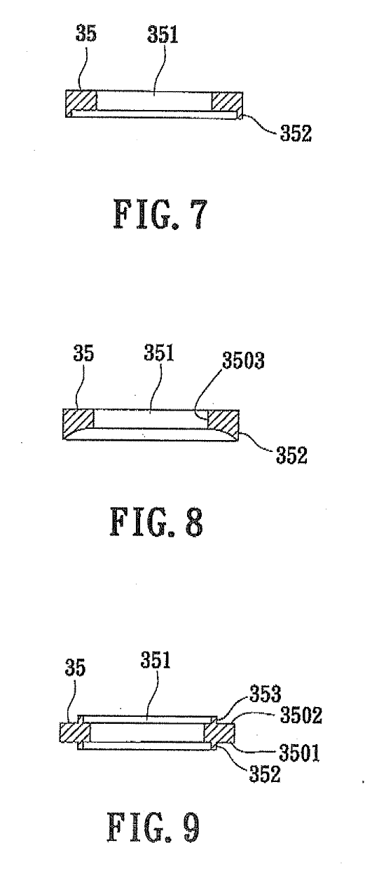

FIG. 6 illustrates another modified protective cushion 35 that is formed with a first protrusion 352 protruding axially from the first side surface 3501 thereof. The first protrusion 352 is disposed adjacent to and surrounds the central hole 351 to reduce the contact area between the protective cushion 35 and the end collar 34. If the first protrusion 352 is worn off, the rest of the protective cushion 35 can still serve as an intermediate buffer between the end collar 34 and the gland body 36. The first protrusion 352 may also be distal from the central hole 351, as illustrated in FIG. 7.

FIG. 8 illustrates yet another modified protective cushion 35 in which the first protrusion 352 has a concave end surface such that a thickness of the protective cushion 35 is reduced in the radial direction from an outer diameter toward the inner annular surface 3503.

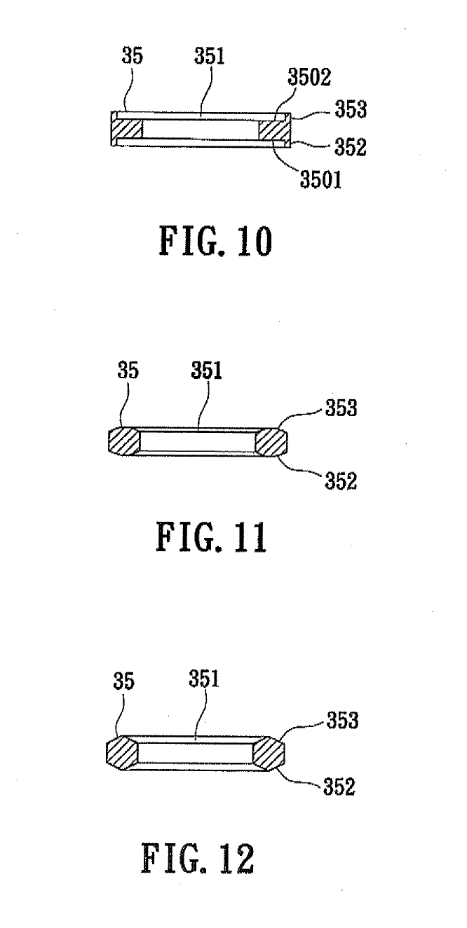

FIGS. 9 and 10 illustrates still another modified protective cushion 35 that is formed with the first protrusion 352 on the first side surface 3501, and is further formed with a second protrusion 353 on the second side surface 3402. The first and second protrusions 352, 353 may be adjacent to the central hole 351 (see FIG. 9), or distal from the central hole 351 (see FIG. 10).

Each of the first and second protrusions 352, 353 may also has a convex end surface as illustrated in FIG. 11, or an inverted V-shaped end surface as shown in FIG. 12.

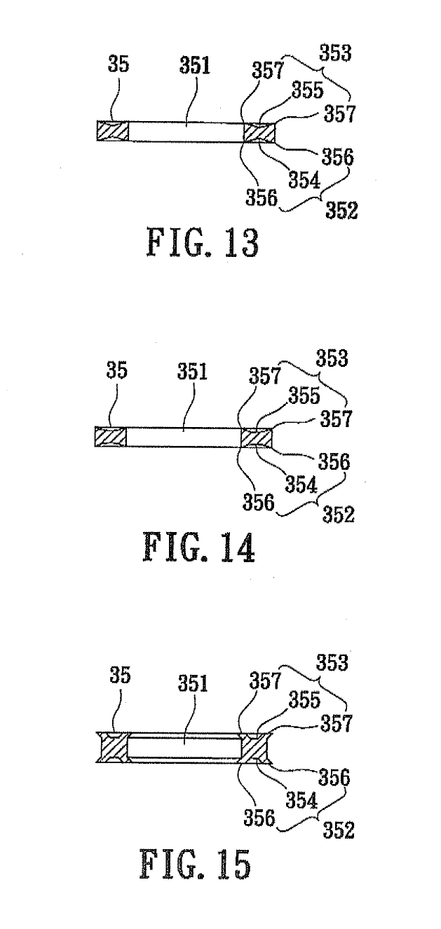

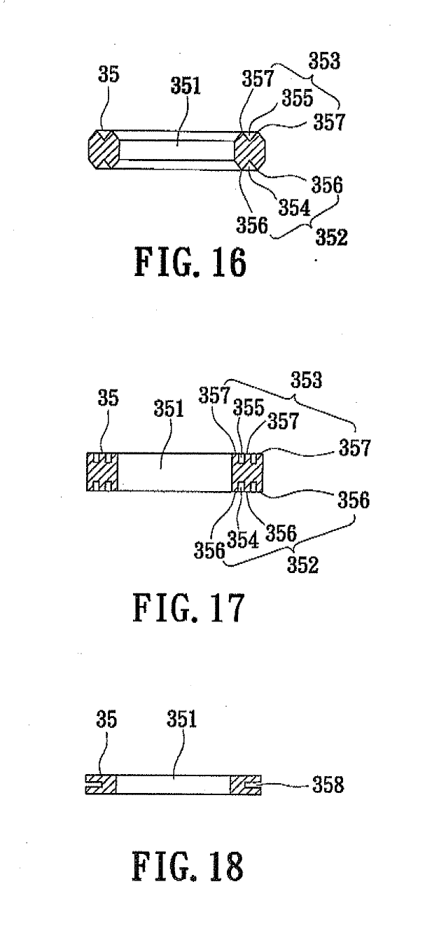

As shown in FIGS. 13 to 16, the end surface of each of the first and second protrusions 352, 353 may be configured as a recessed surface 354, 355, such as a V-shaped recessed surface (see FIGS. 13 and 16) or a U-shaped recessed surface (see FIGS. 14 and 15). As such, each of the first and second protrusions 352, 353 has a pair of contact portions 356, 357 on two sides of the recessed surface 354, 355.

Referring to FIG. 17, the recessed surface 354, 355 of each of the first and second protrusions 352, 353 maybe formed with a pair of recesses and three contact portions 356, 357.

Additionally, as shown in FIG. 18, the protective cushion 35 maybe further formed with an annular groove 358 on an outer circumferential surface that is radially opposite to the inner annular surface 3503.

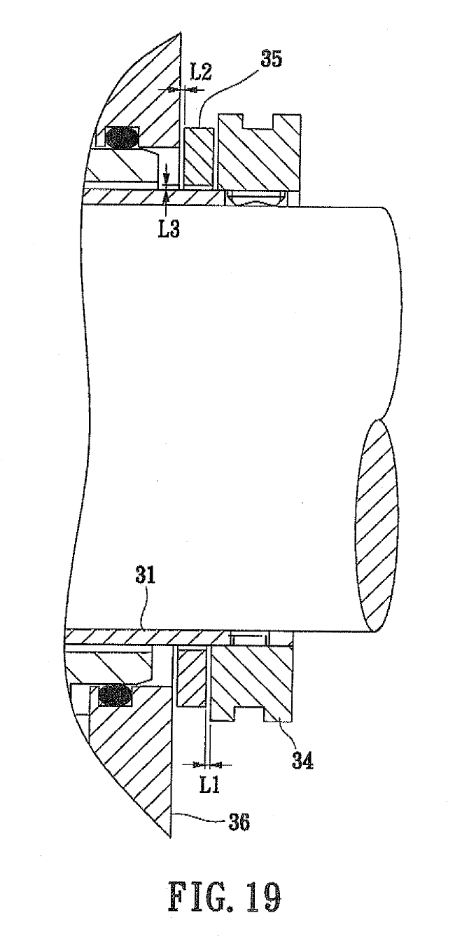

Referring to FIG. 19, the protective cushion 35 may also be configured to have a smaller thickness than the abovementioned modifications, so that the first side surface 3501 and the end collar 34 define a first gap (L1) therebetween, and that the second side surface 3502 and the gland body 36 define a second gap (L2) therebetween. Preferably, each of the first and second gaps (L1, L2) has a width in the axial direction (L) not smaller than 0.5 millimeters. The inner annular surface 3503 may be configured to cooperate with the sleeve 31 to define therebetween a third gap (L3). Preferably, the third gap (L3) has a radial width in a radial direction not smaller than 0.05 millimeters. The configuration further enhances the smoothness of the rotary shaft 41 along with the sleeve 31, and can further alleviate the wear between the protective cushion 35 and the gland body 36, and the wear between the protective cushion 35 and the end collar 34.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A seal device comprising:
a sleeve adapted to be sleeved on a rotary shaft of a pumping machine and having inner and outer end portions that are spaced apart from each other in an axial direction;
a gland disposed around said sleeve, and formed with a through hole that permits extension of said sleeve, and a receiving groove that communicates fluidly with said through hole and that is adapted for receiving cooling fluid;
a sealing assembly sleeved on said sleeve and connected to said gland;
an end collar disposed around said sleeve and outside said gland; and
a protective cushion disposed around said sleeve and between said gland and said end collar.

2. The seal device as claimed in claim 1, wherein said gland is further formed with a pair of circulation holes communicating fluidly with said receiving groove for permitting the cooling fluid to enter and exit said receiving groove, respectively.

3. The seal device as claimed in claim 2, further comprising a rotatable propelling ring disposed around said sleeve and within said receiving groove, and has an outer periphery formed with a propelling groove that is adapted for propelling the cooling fluid.

4. The seal device as claimed in claim 1, wherein said sealing assembly includes:
a rotary ring sleeved co-rotatably on said sleeve;
a stationary ring disposed around said sleeve and having an inner end that abuts against said rotary ring and an outer end that is opposite to said inner end in the axial direction;
an abutment ring disposed around said sleeve and abutting against said outer end of said stationary ring; and
a resilient member having opposite ends that abut respectively against said abutment ring and said gland.

5. The seal device as claimed in claim 1, wherein said protective cushion is formed with a central hole through which said sleeve extends.

6. The seal device as claimed in claim 1, wherein said protective cushion has a first side surface facing said gland and formed with a protrusion that protrudes axially.

7. The seal device as claimed in claim 6, wherein said protrusion of said protective cushion is disposed adjacent to said central hole of said protective cushion,

8. The seal device as claimed in claim 6, wherein said protrusion of said protective cushion has a convex end surface.

9. The seal device as claimed in claim 6, wherein said protrusion of said protective cushion has a recessed surface.

10. The seal device as claimed in claim 1, wherein said protective cushion has opposite first and second side surfaces facing respectively said end collar and said gland, and formed respectively with first and second protrusions that protrude axially.

11. The seal device as claimed in claim 10, wherein each of said first and second protrusions of said protective cushion is disposed adjacent to said central hole of said protective cushion.

12. The seal device as claimed in claim 11, wherein each of said first and second protrusions has a convex end surface.

13. The seal device as claimed in claim 11, wherein each of said first and second protrusions of said protective cushion has a recessed surface.

14. The seal device as claimed in claim 1, wherein said protective cushion is made of engineering plastic.

15. The seal device as claimed in claim 1, wherein said protective cushion is made of a flameproof material.

16. The seal device as claimed in claim 5, wherein said protective cushion has opposite first and second side surfaces facing respectively said end collar and said gland, said first side surface and said end collar defining a first gap therebetween, said second side surface and said gland defining a second gap therebetween, each of said first and second gaps has a width in the axial direction not smaller than 0.5 millimeters.

17. The seal device as claimed in claim 17, wherein said protective cushion further has an inner annular surface defining said central hole, said inner annular surface and said sleeve defining therebetween a third gap that has a radial width not smaller than 0.05 millimeters.
